(19) United States
(12) Patent Application Publication
(10) Pub. No.: US 2005/0243543 A1
(43) Pub. Date: Nov. 3, 2005

(54) Illuminated table and shelf leg tube structure

(76) Inventor: Ren-Ju Tzeng, Beidou Township (TW)

Correspondence Address: RABIN & BERDO, P.C., Suite 500, 1101 14th Street, N.W., Washington, DC, 20005, US

(21) Appl. No.: 10/832,858

(22) Filed: Apr. 28, 2004

(51) Int. Cl. F16L 11/00

(52) U.S. Cl. 362/127

(57) ABSTRACT

An illuminated table and shelf leg tube structure in which a minimum of one port is formed in the leg tube, the port is fitted with a covering shade plate, and a lamp is installed inside the leg tube aligned with the port, thereby enabling the lamp light source to emit light rays through the shade plate. The leg tube has a connector inserted into each of the openings at its top and bottom extremities that enables the respective attachment of a platform and a plinth to its upper extremity and lower extremity and, furthermore, assembly into a table or a shelf structure. As such, the leg tube conceals the lamp, thereby facilitating illumination and utilization.

### BACKGROUND OF THE INVENTION

1) Field of the Invention

The invention herein relates to an illuminated table and shelf leg tube structure that provides for use in various furniture such as shelves, desks, and cabinets.

2) Description of the Prior Art

Conventional furniture such as shelves, desks, and cabinets lack built-in lighting equipment and typically lighting equipment is bought separately. In terms of usage, lighting equipment is placed on the said shelves, desks, and cabinets. However, consumers must not only additionally purchase lighting equipment which involves an increase in buying costs, but also risk the possibility that lighting equipment placed on shelves and desks might accidentally be knocked down by persons and damaged which, furthermore, would adversely affect environmental attractiveness.

### SUMMARY OF THE INVENTION

The objective of the invention herein is to provide an illuminated table and shelf leg tube structure in which a lamp is installed inside a leg tube such that it emits light outwards, with the lamp concealed and not occupying space and, furthermore, providing for desk and shelf product designs that are even more visually attractive.

### BRIEF DESCRIPTION OF THE DRAWINGS

FIG. 1 is an exploded drawing a leg tube structure.

FIG. 2 is a cross-sectional drawing of the leg tube structure (light bulb installed).

FIG. 3 is a cross-sectional drawing of another leg tube structure embodiment (light bulb installed).

FIG. 4 is an isometric drawing of a leg tube structure embodiment.

FIG. 5 is an isometric drawing of a leg tube structure embodiment.

FIG. 6 is an isometric drawing of a leg tube structure embodiment.

FIG. 7 is an isometric drawing of a leg tube with a platform and a plinth assembled into a shelf.

FIG. 8 is an isometric drawing of a leg tube with a platform and a plinth assembled into another shelf.

FIG. 9 is an isometric drawing of a leg tube application embodiment (a shelf).

FIG. 10 is an isometric drawing of a leg tube application embodiment (a shelf).

FIG. 11 is an isometric drawing of a leg tube application embodiment (a shelf).

FIG. 12 is an isometric drawing of a leg tube application embodiment (a shelf).

FIG. 13 is an isometric drawing of a leg tube application embodiment (a table).

FIG. 14 is an isometric drawing of a leg tube application embodiment (computer desk).

FIG. 15 is an isometric drawing of a leg tube application embodiment (a bed).

FIG. 16 is an isometric drawing of a leg tube application embodiment (a computer desk).

FIG. 17 is an isometric drawing of a leg tube application embodiment (a shelf).

### DETAILED DESCRIPTION OF THE PREFERRED EMBODIMENTS

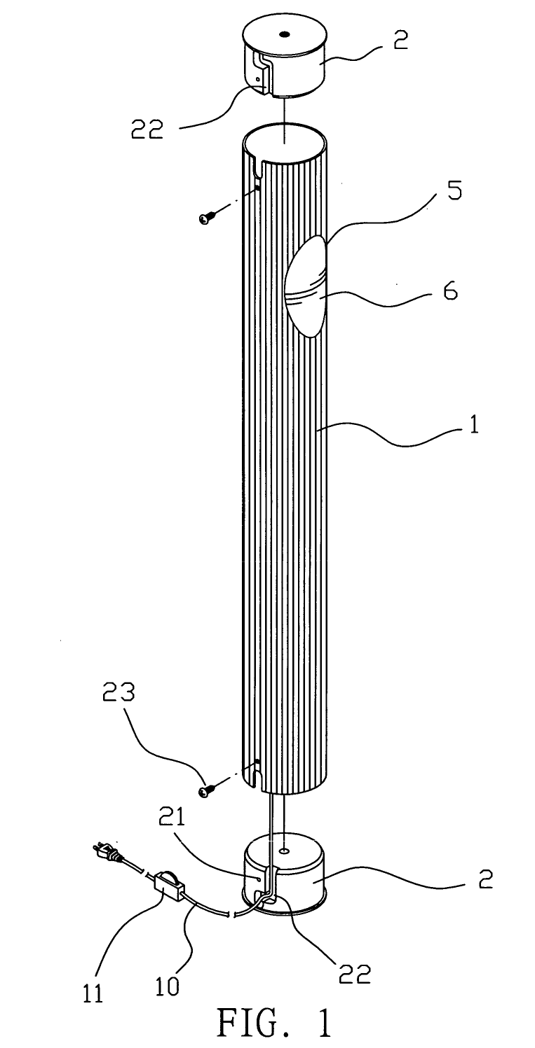

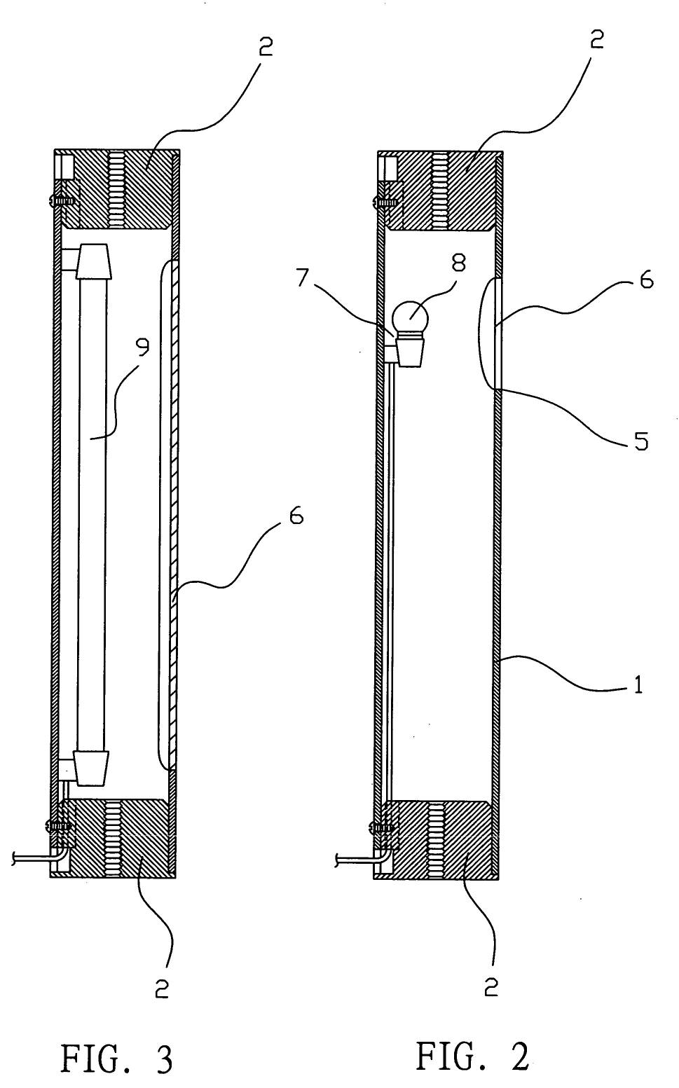

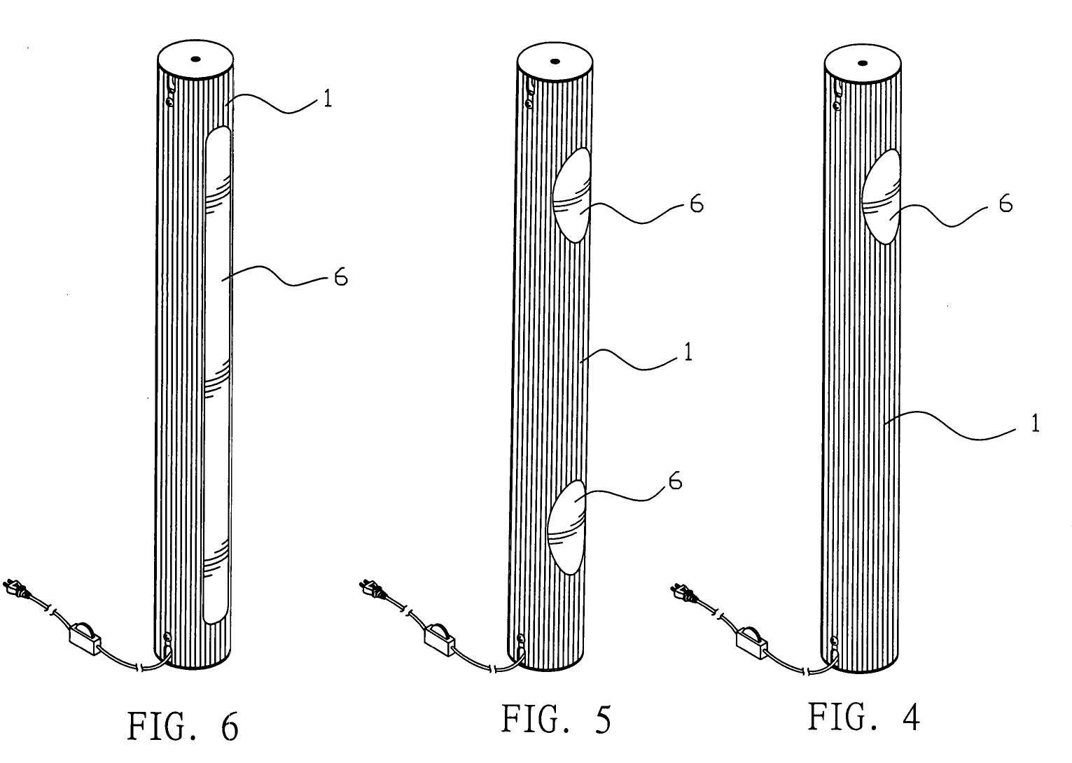

FIG. 1 is an exploded drawing a leg tube structure. FIG. 2. is a cross-sectional drawing of the leg tube structure (light bulb installed). FIG. 3 is a cross-sectional sectional drawing of another leg tube structure embodiment (light bulb installed). FIG. 4 is an isometric drawing of a leg tube structure embodiment. FIG. 5 is an isometric drawing of a leg tube structure embodiment. FIG. 6 is an isometric drawing of a leg tube structure embodiment. In the illuminated table and shelf leg tube structure of the invention herein, the said leg tube 1 has a connector 2 inserted into each of the openings at its top and bottom extremities, each connector 2 consisting of threaded hole 21 and a slot 22 at one side that enables the fastening of each connector 2 into the leg tube 1 by means of a screw 23, with the connectors 2 also providing for the later assembly of a platform and a plinth to the upper extremity and lower extremity, respectively, of the leg tube 1, the platform and the plinth constructed of a glass, a wood, steel, or ceramic panel; wherein, a minimum of one port 5 is formed at a predetermined location in the leg tube 1 and, as shown in FIG. 4, FIG. 5, and FIG. 6, the port 5 is fitted with a covering shade plate 6, a lamp 7 is installed inside the leg tube 1 aligned with the port 5, the lamp 7 can be light bulb 8 or a lamp tube 9 from which a power cord 10 extends outside, the power cord 10 having a power switch 11, thereby enabling the lamp 7 light source to emit light rays through the shade plate 6.

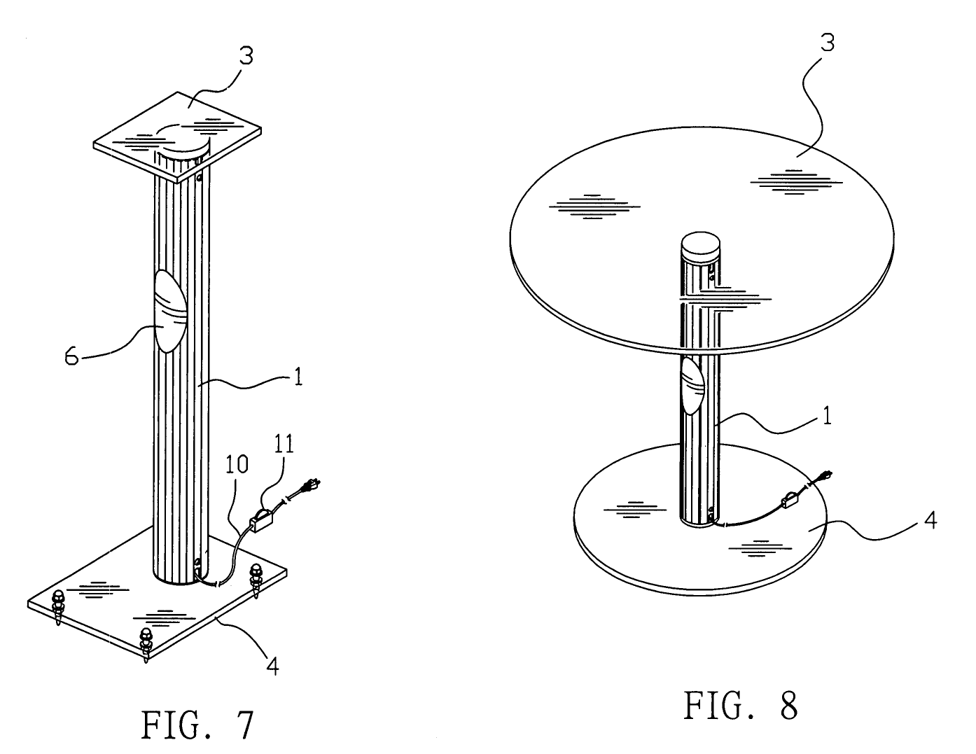

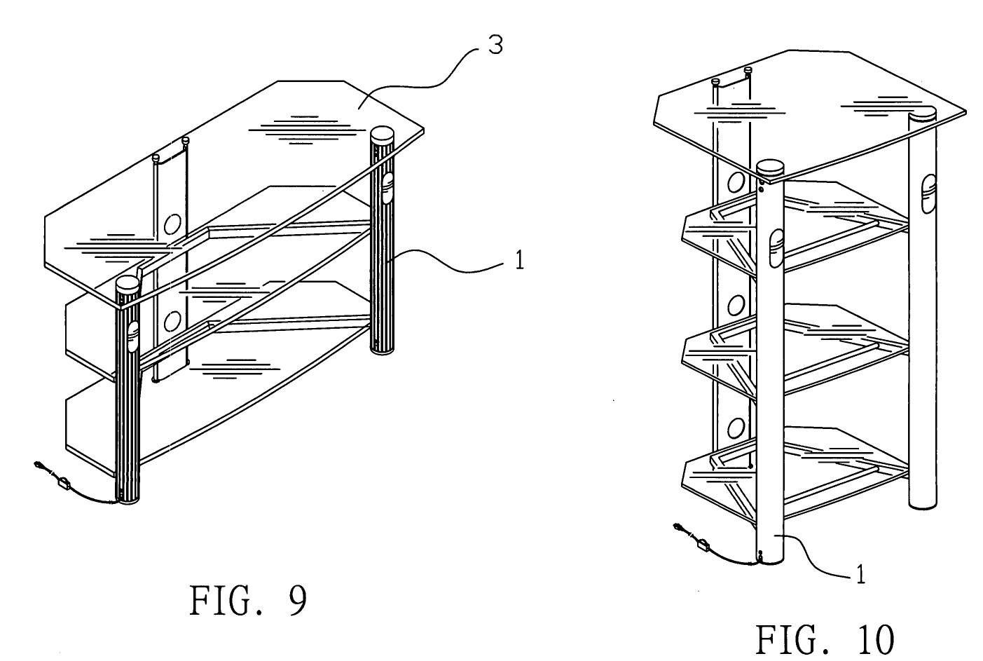

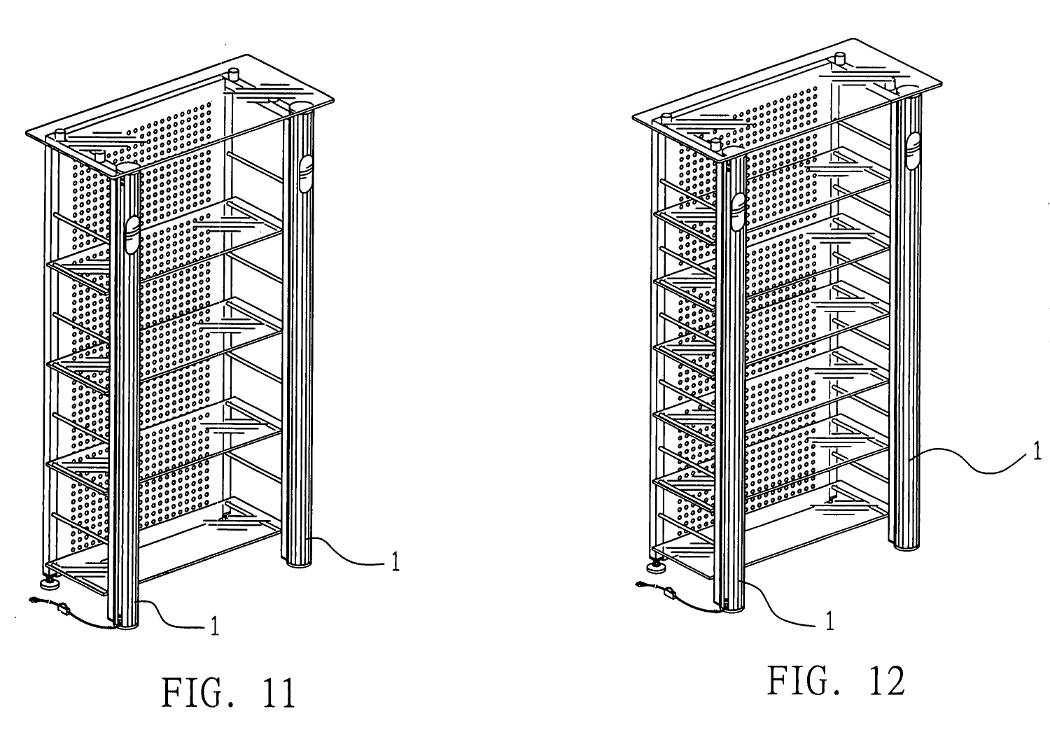

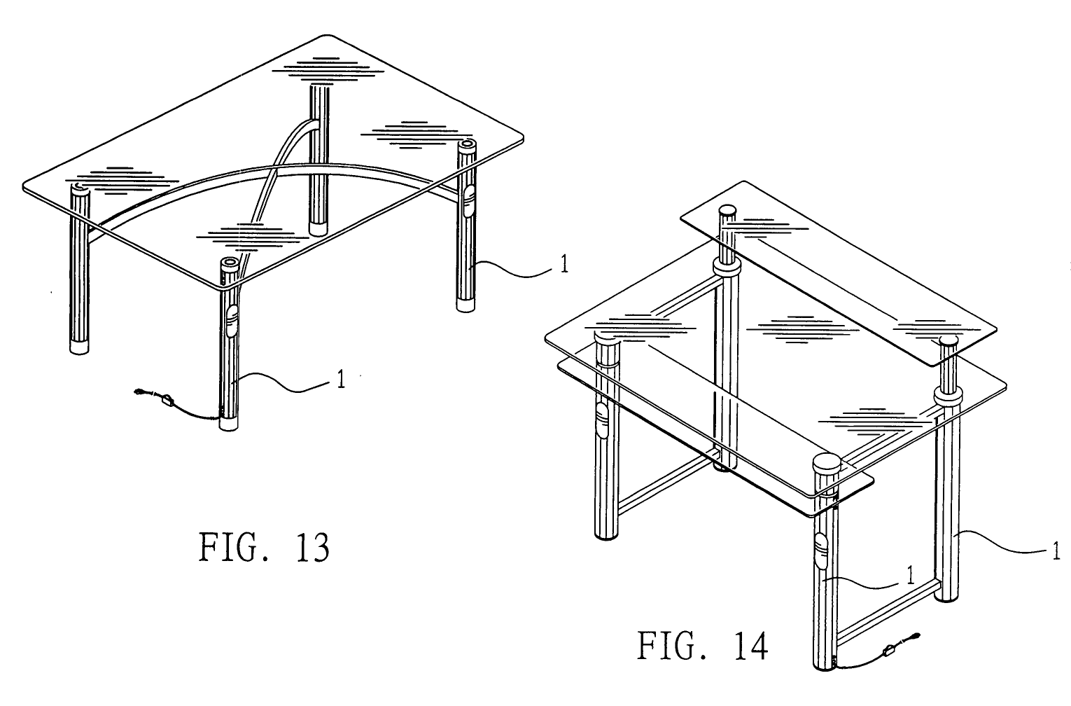

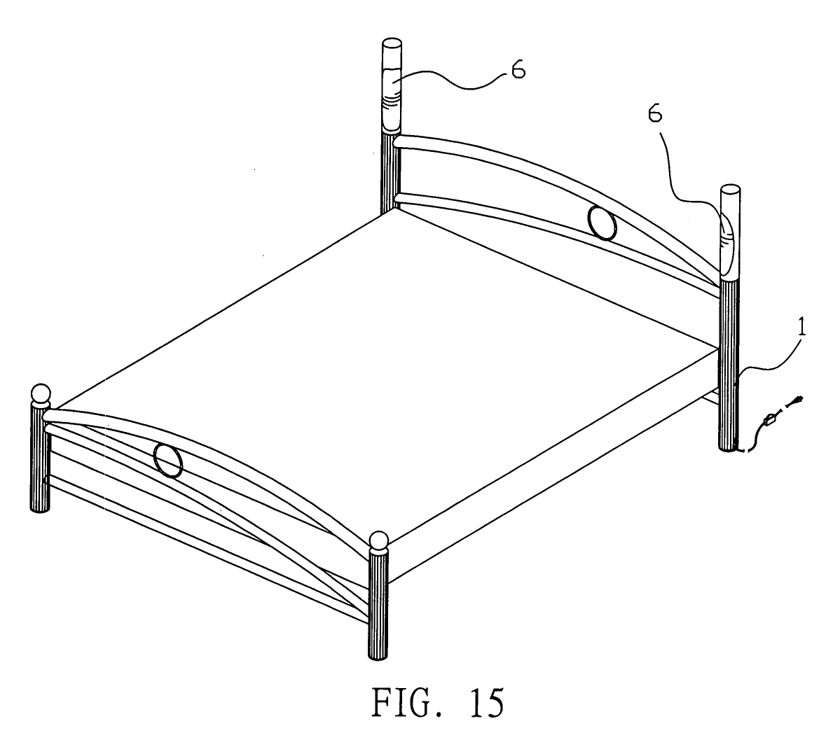

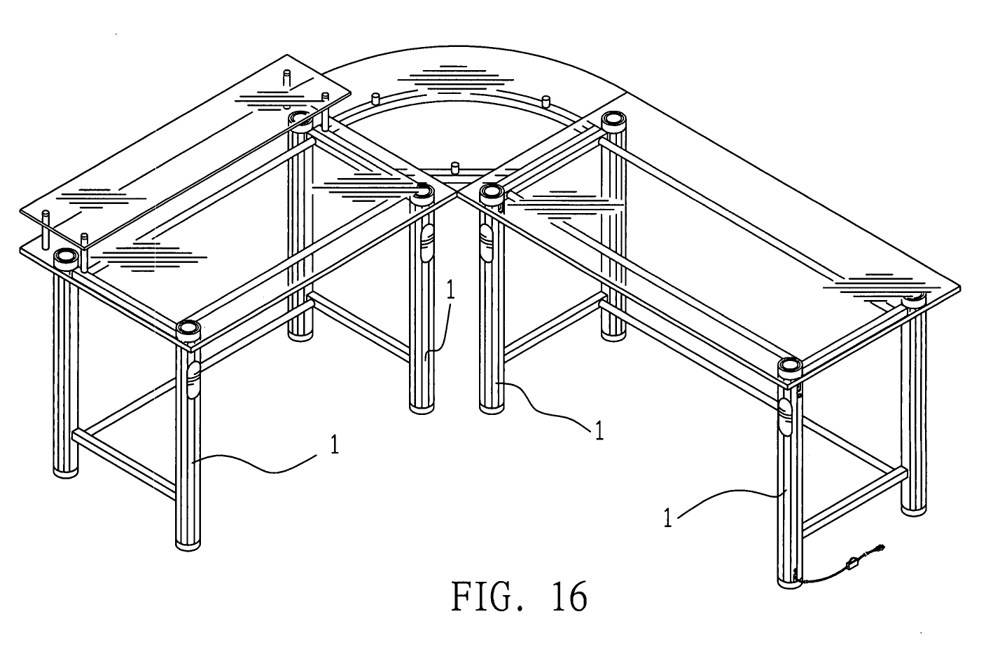

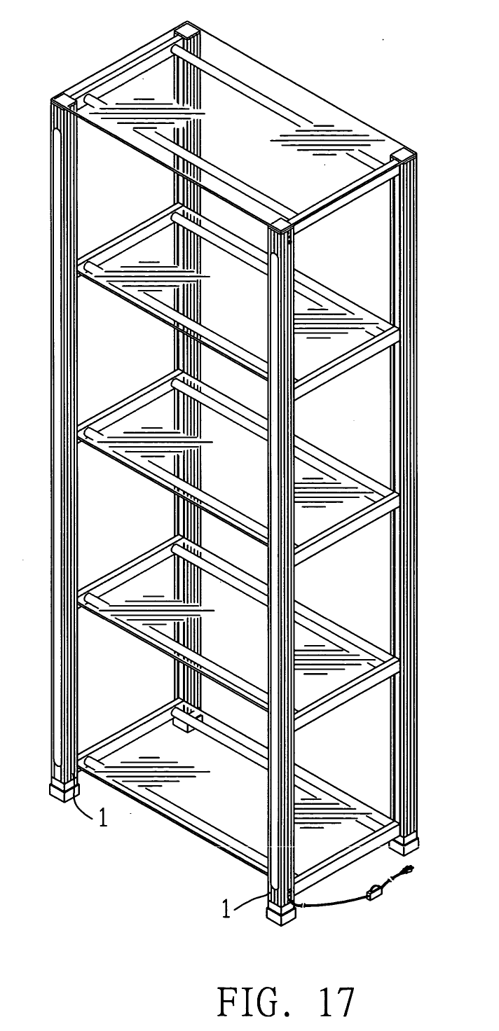

FIG. 7 is an isometric drawing of a leg tube 1 with a platform 3 and a plinth 4 assembled into a shelf. FIG. 8 is the isometric drawing of a leg tube 1 with a platform 3 and a plinth 4 assembled into another shelf. FIG. 9 is an isometric drawing of a leg tube 1 application embodiment (a shelf). FIG. 10 is an isometric drawing of a leg tube 1 application embodiment (a shelf). FIG. 11 is an isometric drawing of a leg tube 1 application embodiment (a shelf). FIG. 12 is an isometric drawing of a leg tube 1 application embodiment (a shelf). FIG. 13 is an isometric drawing of a leg tube 1 application embodiment (a table). FIG. 14 is an isometric drawing of a leg tube 1 application embodiment (computer desk). FIG. 15 is an isometric drawing of a leg tube 1 application embodiment (a bed). FIG. 16 is an isometric drawing of a leg tube 1 application embodiment (a computer desk). FIG. 17 is an isometric drawing of a leg tube 1 application embodiment (a shelf).

In summation of the foregoing section, the invention is original and progressive and, furthermore, the said description only elaborates the most preferred embodiments of the present invention and shall not be construed as a limitation on the scope of the said embodiments. All modifications and embellishments based on the patent application claims shall remain included in the patent claims of the invention herein, which is submitted to the patent bureau for review and the granting of the commensurate patent rights.

1. An illuminated table and shelf leg tube structure, the leg tube having a platform and a plinth respectively assembled to its upper extremity and lower extremity, wherein a minimum of one port is formed in the said leg tube, the said port is fitted with a covering shade plate, and a lamp is installed inside the said leg tube aligned with the said port, thereby enabling the said lamp light source to emit light rays through the said shade plate.

2. As mentioned in claim 1 of the illuminated table and shelf leg tube structure of the invention herein, the said leg tube has a connector inserted into each of the openings at its top and bottom extremities, the said connectors are conjoined to the said platform and the said plinth, and each said connector consists of a threaded hole and a slot at one side that enables the fastening of each said connector into the said leg tube by means of a screw and, furthermore, assembly into a table or a shelf structure.

3. As mentioned in claim 1 of the illuminated table and shelf leg tube structure of the invention herein, the said lamp has a power cord extending from it and the said power cord has an integrated power switch to control the switching ON and OFF of the said lamp.

4. As mentioned in claim 1 of the illuminated table and shelf leg tube structure of the invention herein, the said leg tube has the said platform assembled to its upper extremity.

5. As mentioned in claim 1 of the illuminated table and shelf leg tube structure of the invention herein, the said leg tube has the said plinth assembled to its lower extremity.

6. As mentioned in claim 4 of the illuminated table and shelf leg tube structure of the invention herein, the said platform is a glass, wood, steel, or ceramic panel.

7. As mentioned in claim 5 of the illuminated table and shelf leg tube structure of the invention herein, the said plinth is a glass, wood, steel, or ceramic panel.

8. As mentioned in claim 1 of the illuminated table and shelf leg tube structure of the invention herein, the said shade plate is a translucent structure.
